(19) United States
(12) Patent Application Publication
(10) Pub. No.: US 2010/0062710 A1
(43) Pub. Date: Mar. 11, 2010

(54) MONITORING FOR THE PRESENCE OF A RADIO-COMMUNICATING MODULE IN THE VICINITY OF A RADIO-COMMUNICATING TERMINAL

(75) Inventor: Bruno Graff, La Rochelle (FR)

Correspondence Address: FISH & RICHARDSON P.C., PO BOX 1022, MINNEAPOLIS, MN, 55440-1022, US

(73) Assignee: LOGINCUBE, Luxembourg (LU)

(21) Appl. No.: 12/298,030

(22) PCT Filed: Apr. 23, 2007
(86) PCT No.: PCT/FR2007/051157

§ 371 Date: Nov. 24, 2009

(30) Foreign Application Priority Data
Apr. 21, 2006 (FR) 0651423

(51) Int. Cl. H04B 7/00; H04B 17/00

(52) U.S. Cl. 455/41.2; 455/67.11

(57) ABSTRACT

The invention relates to a method of determining the presence or otherwise in a zone of defined size around a master radio-communicating terminal, of a peripheral radio-communicating module, the radio-communicating terminal and module operating according to a radio communication protocol of BLUETOOTH® type and under the dependence of application programs, the protocol having means for retransmitting data from the module when the reception of said data by the terminal is incomplete or erroneous, this being so for a maximum re-try time, the data not being considered to have been received unless the reception of all the data is correct in the course of the maximum re-try time, the data exchanges being characterized by a transmission error rate. According to the invention, after the master terminal (1) recognizes the presence of the peripheral module (2), at a time T0, the master terminal despatches a test data block request to the module and then is on standby awaiting reception of said test data block of defined size for a determined duration D, the peripheral module having a limitation of the transmission power that is constant for the test data block, the correct reception of said test data block by the terminal over the determined duration D indicating the presence of the module in the zone of defined size. A system, a peripheral module and an application complete the invention.

This invention involves a determination process and system for the presence of a radio-communicating module in the vicinity of a radio-communicating terminal, as well as an adapted module. It has some applications in the monitoring and safety domain, specifically in the case where the module is carried by a person whose movements one wishes to monitor.

Systems are known permitting learning the position of people fairly precisely such as for example GPS or GSM. However, apart from the fact they are intended rather for positioning on a large scale and are relatively less precise in the case of movements over small distances, these systems are costly and relatively bulky.

This invention proposes to use standardized, low cost and low consumption radio-communication equipment to permit learning a person's position (or that of an object) in a restricted environment. For example it can be used for monitoring a child carrying a radio-communicating module, specifically in the form of a watch, and to permit the generation of alarms when the child either moves too far away or, on the contrary, comes too close, to a radio-communicating terminal. It is based on the fact that some transmission protocols have the means to make re-transmissions in case of failure or error in the transmission, a variation in the number of transmissions exists until validation (transmission finally correct) at least based on the distance with other parameters constant, specifically, the restriction of the emission power, the receiver sensitivity, the encoding method, the noise . . . .

In order that the invention works, this characterization of the number of re-transmissions until validation does not perforce need to be known precisely but if it is known precisely it can permit refining the distance evaluation. It can be known precisely a priori or, better, a posteriori, by a calibration of the system in its final working environment.

Thus, the invention involves a determination process of the presence or absence of a radio-communicating peripheral module in a zone of defined size around a radio-communicating master terminal. The radio-communicating terminal and the module are able to exchange data and operate according to a BLUETOOTH® type radiocommunication protocol and under the control of applications programs. The radiocommunication protocol has some means for transmitting data from the module when the reception of the aforesaid data by the terminal is incomplete or erroneous, and does so during a determined maximum time of re-testing. The data is only considered received if the reception of the whole of the data is correct during the maximum time of re-testing. The data exchanges are characterized by a number of re-transmissions until validation of a transmission at least based on the size of a data block, the restriction of the emission power and the distance between the equipment.

According to the invention, after recognition of the peripheral module's presence by the master terminal, at a time T0, the master terminal sends a request for a test data block to the module then passes to wait on reception of the aforesaid test data block of defined size for a determined duration D. The peripheral module has a limitation on constant emission power for the test data block. The correct reception of the aforesaid test data block by the terminal during the duration determined D indicates the presence of the module in the defined size zone.

In various embodiment modes of the invention, the following resources may be used either alone or according to all the technically possible combinations:
the master terminal is a microcomputer with a radio-communicating interface,
the master terminal is a personal data assistant (PDA) with a radio-communicating interface,
the master terminal is a cell phone with a radio-communicating interface,
the master terminal is a dedicated device including a microprocessor or a micro-controller and with a radio-communicating interface,
the peripheral module is in a watch, (wrist or anklet)
the peripheral module is in a broach,
the peripheral module is in a pendant, (necklace around the neck),
the determined duration D has a value greater or equal to the maximum time for re-testing,
the determined duration D is a value between 1 and 6 seconds,
the determined duration D is by preference a value between 1 and 2 seconds,
the defined size of the zone is selected in which the determination takes place by prior selection of the limitation on the emission power of the peripheral module for the test data block, (if the zone size is small the limitation on the highest power is selected, if the zone size is large the limitation on the lowest power is selected)
the defined size of the zone corresponds to one distance interval,
the terminal and the module can recognize each other up to a maximum distance and the determination is done with a selection in 5 successive zones included within the maximum distance,
the maximum distance is the order of 30 m,
the distance intervals are roughly delimited by the following markets: 3 m, 7 m, 10 m, 15 m, 20 m, 30 m,
the limitation on the emission power of the peripheral module is selected directly by means of selection in the module itself,
the limitation on the emission power transmitted to the terminal of the peripheral module is made directly by means of module selection,
the limitation on the emission power of the peripheral module is selected on the master terminal and the selection transmitted to the module,
the distances on the master terminal between the master terminal and the peripheral module are estimated in addition by repeating the determination process while varying the limitation on the emission power of the peripheral module between repetitions. The limitation on the emission power level from which a correct reception of the test data block is possible or impossible according to the case, gives an evaluation of the distance,
the test data block includes a number of data greater than the number of data transmitted by the module and necessary for the recognition between the terminal and the module,
the test data block has a size of about 64 to 128 bytes,
in addition, there are several test data blocks differing from each other in number of data (bytes) and the block used is chosen for the determination according to the determined size of the zone to be monitored, (by preference, if the zone size is small it uses a block including more data)
the distance intervals are delimited approximately by the following markers: 3 m, 7 m, 10 m, 15 m, 20 m, 30 m, there are two test data blocks differing from each other by their number of bytes and the block with less data is used between 30 m and 15 m and the block with more data between 15 m and 3 m,
the determination process is repeated over time and the master terminal includes a means to generate an alarm and according to a selection, the alarm is generated either when the correct reception of the block is no longer possible (in the given time of re-testing) or because, specifically, the module leaves the zone, or when the reception of the block becomes possible because, specifically, the module penetrates into the zone,
when the correct reception of the block is no longer possible either because, specifically, the module leaves the zone the master terminal performs a new search for the presence of the peripheral module, the alarm generated is different depending on whether the recognition is possible or not, (apart from the module effectively leaving zone, in other cases it may have been stopped/the zone size changed)
when the correct reception of the block is no longer possible because, specifically, the module leaves the zone the master terminal performs in addition a new recognition for the presence of the peripheral module, the alarm is only generated if recognition is possible,
a set of modules is present in the environment of the master terminal and at the time of the recognition each module that must be monitored is identified and the determination is made specifically for each of the aforesaid modules to be monitored.

The invention also involves a system for the embodiment of a process of determination of the presence or absence in a zone of defined size of an radio communicating equipment, characterized in that it includes one master radio-communicating terminal and at least one radio-communicating peripheral module. The zone size defined is around the radio-communicating master terminal, the radio communicating equipment is the radio-communicating peripheral module. The terminal and the radio-communicating module are able to exchange data and operate according to a BLUETOOTH® type radiocommunication protocol. and under the control of applications programs. The radiocommunication protocol has a means of transmitting data from the module when the reception of the aforesaid data by the terminal is incomplete or erroneous, and during a determined maximum time of re-testing, the data blocks are only considered received if the reception of the whole of the data is correct during the maximum time of re-testing. The data exchanges are characterized by a number of re-transmissions until at least (one) transmission validation based on the size of the data block, the emission power and the distance between the equipment and that includes some means for the execution of the process according to one or several of the previous characteristics and in which after recognition by the master terminal of the presence of the peripheral module, at a time T0, the master terminal sends a request to the module for a test data block then passes to wait on reception of the aforesaid test data block of defined size for a determined duration D. The peripheral module has a limitation on the constant emission power for the test data block, the correct reception of the aforesaid test data block by the terminal during the determined duration D indicates the presence of the module in the defined size zone.

The invention also concerns a radio communicating module, that is a peripheral module as a watch and that includes some means to operate in the previous system and according to the previous process and in all its variants.

The invention finally involves an application of the previous process in all its variants for monitoring of a person's movements who carries the aforesaid peripheral module as a watch.

This invention, insofar as it is not limited, will now be exemplified with the description that follows in relation with the following FIGURE:

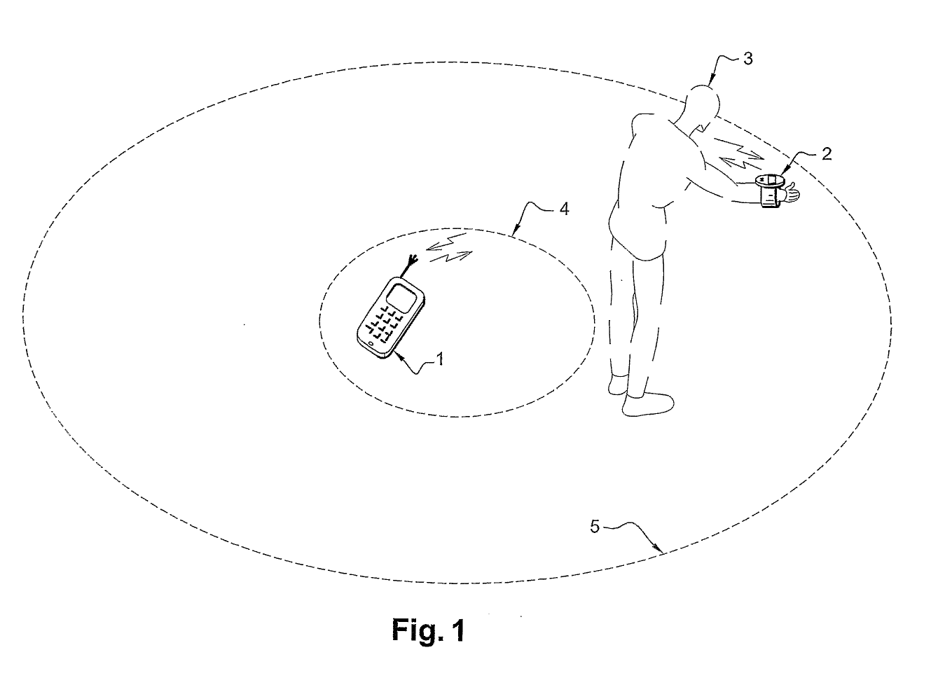

FIG. 1 that schematically represents a monitoring system with a master terminal dialoguing with a peripheral module carried by a person for which the movements must be supervised.

The master terminal 1 from FIG. 1 is here a programmable computer device of the personal data assistant (PDA) type with applications program and include a means of radio-communication according to a BLUETOOTH® type protocol.

In a variant a telephone programmable through an application with means of radio-communication according to a BLUETOOTH® type protocol can be used. The master terminal can detect the presence and can identify all compatible radio-communication equipment that is introduced into its environment delimited on FIG. 1 by the closed curve 5. One such equipment is already present in the form of a peripheral module 2 in a watch carried by a person 3 whose movements must be supervised. The module has been identified by the terminal and the data exchanges for monitoring by determination of the presence or absence of the module 2 in a defined size zone around the terminal are going to be done specifically with the identification obtained. The zone size defined around the terminal is delimited on FIG. 1 by the closed curve 4 that is recorded inside curve 5. The emission power of the test data block has been chosen as a result thereof. At the time of the monitoring, essentially the terminal emits regularly (with a periodicity a little greater than the maximum determined time of re-testing) to the module a request so that the module returns a test data block with limitation on the chosen emission power. Whilst the reception of the block by the module is correct, which is the case before anyone leaves the zone, the module is considered as being in the zone. On FIG. 1, the person left the zone and the terminal, in spite of transmissions because of successive failures of reception which has caused some re-testing, does not manage to receive the block correctly in the maximum determined time of re-testing, which leads the system to consider that the module left the zone. According to the monitoring modes, detection of remoteness or, on the contrary, detection of proximity, the alarm will be triggered at the time of the impossibility of reception or at the time of the appearance of a correct reception. This latter case can be useful for example in the case of a child in a kitchen, the terminal being in relation with four surface cooking rings and provided when the oven is hot or the plates hot, the child's approach then causes an alarm only in these cases.

The transmission being made in the space, the sizes of zones or the intervals of distance, for the same test data block is not distributed linearly as a function of the emission power (cubic variation) and if you desire the sizes of zones or distance intervals to be linear you may either vary the limitation of power according to a cubic variation, or modify the test data block so that it is longer or shorter or more or less complex (use of a block with another number of retransmissions until validation of transmission greater than the average).

It is understood that other alternatives of embodiment are possible as well as of other applications of the process and, realized, without leaving the general scope of the invention. In particular, implementation of another radio-communication protocol that has some means for rebroadcast of data from the module when the reception of the aforesaid data by the terminal is incomplete or erroneous, and during a determined maximum time of re-testing. The data is only considered received if the reception of all data is correct during the maximum time of re-testing. The master terminal can be connected to other devices, specifically remote transmission of alarms, for triggering various devices . . . . Some applications with animals may be made to generate an alarm in case of roaming. Finally, as an alternative or in combination with the modification of the size of the test data blocks to have different numbers of retransmissions, in the case where test data blocks exist that cause, with equal size (and the other parameters being equal: limitation of power, distance . . . ), more retransmissions than the average of all possible blocks, these blocks with higher number of re-transmissions can be use for the execution of the invention process.

1. Process for determination of the presence or absence in a defined size zone around a radio-communicating master terminal, of a radio-communicating peripheral module, where the terminal and the radio-communicating module may exchange data and operate according to a radiocommunication BLUETOOTH® type protocol, and under the control of applications programs. The radiocommunication protocol has some means for re-transmission of data from the module when the reception of the aforesaid data by the terminal is incomplete or erroneous, and during a determined maximum time of re-testing. The data is only considered received if the reception of the whole of the data is correct for the maximum time of re-testing. The data exchanges are characterized by a number of re-transmissions until the validation of one transmission at least based on the size of a block of data, the limitation on the emission power and the distance between the equipment,
characterized in that after recognition by the master terminal (1) of the presence of the peripheral module (2), at a time T0, the master terminal sends a request for a test data block to the module then passes to wait on reception of the aforesaid test data block of defined size for a determined duration D, the peripheral module has a limitation on the constant emission power for the test data block, the correct reception of the aforesaid test data block by the terminal during the determined duration D indicates the presence of the module in the defined size zone.

2. Process according to claim 1, characterized in that the defined size of the zone is selected in which the determination takes place by prior selection of the limitation on emission power of the peripheral module for the test data block.

3. Process according to claim 2, characterized in that the limitation on the emission power of the peripheral module is selected directly by the selection means of the module itself.

4. Process according to claim 1 or 2, characterized in that the limitation on the emission power of the peripheral module is selected on the master terminal and that the selection is transmitted to the module.

5. Process according to claim 3, characterized in that in addition the distance is estimated on the master terminal between the master terminal and the peripheral module by repeating the determination process while varying the limitation on the emission power of the peripheral module between the repetitions. The limitation level on the emission power from which a correct reception of the test data block is possible or impossible according to the case, gives an estimation of the distance.

6. Process according to any one of the previous claims, characterized in that the test data block includes a number of data greater than the number of data transmitted by the module and necessary for recognition between the terminal and the module.

7. Process according to claim 6, characterized in that in addition, there are several test data blocks differing from each other by their number of data and that the block is chosen used for the determination according to the determined zone size to be monitored.

8. Process according to any one of the previous claims, characterized in that the determination process is repeated over time and that the master terminal includes a means to generate an alarm and that according to a selection, the alarm is generated either when the correct reception of the block is no longer possible because, specifically, the module leaves the zone, or when the reception
of the block becomes possible because, specifically, the module penetrates into the zone.

9. System for the implementation of a process of determination of the presence or absence in a zone of defined size of a radio communicating equipment, characterized in that it includes a radio-communicating master terminal and at least one radio-communicating peripheral module. The defined zone size is around the radio-communicating master terminal, the radio communicating equipment is the radio-communicating peripheral module, the terminal and the radio-communicating module capable of exchanging data and operating according to a BLUETOOTH® type radiocommunication protocol and under the control of applications programs. The radiocommunication protocol has some means for data retransmission from the module when the reception of the aforesaid data by the terminal is incomplete or erroneous, and over a determined maximum time of re-testing, the data is only considered received if the reception of the whole of the data is correct over the maximum time of re-testing, the data exchanges are characterized by a number of re-transmissions until validation of at least one transmission based on the size of a data block, the limitation on the emission power and the distance between the equipment. Also the equipment includes some means for the execution of the process of any one of the previous claims and after recognition by the master terminal of the presence of the peripheral module, at a time T0, the master terminal sends a request for a test data block to the module then passes to wait on reception of the aforesaid test data block of defined size for a determined duration D, the peripheral module has a limitation on the constant emission power for the test data block, the correct reception of the aforesaid test data block by the terminal for the determined
duration D indicates the presence of the module in the defined zone size.

10. Radio communicating module, characterized in that it is a peripheral module such as a watch and that it includes some means to operate in the system of claim 9 and according to the process of one of any the previous claims.

11. Application of the process of any one of the claims 1 to 8, characterized in that it is monitoring a person's movements with the peripheral module carried as a watch.
